(19) United States
(12) Patent Application Publication
(10) Pub. No.: US 2007/0291632 A1
(43) Pub. Date: Dec. 20, 2007

(54) Method for Detecting Symbol Timing of Multi-Antenna Radio Communication System

(75) Inventors: Haitao Li, Beijing (CN); Jifeng Li, Kanagawa (JP)

Correspondence Address: STEVENS, DAVIS, MILLER & MOSHER, LLP, 1615 L. STREET N.W., SUITE 850, WASHINGTON, DC, 20036, US

(73) Assignee: Matsushita Electric Industrial Co., Ltd., Osaka (JP)

(21) Appl. No.: 11/575,831

(22) PCT Filed: Sep. 22, 2005
(86) PCT No.: PCT/JP05/17507

§ 371 Date: Mar. 22, 2007

(30) Foreign Application Priority Data
Sep. 24, 2004 (CN) 200410011880.9

(51) Int. Cl. H04J 11/00; H04B 7/005

(52) U.S. Cl. 370/203; 455/68

(57) ABSTRACT

There is provided a method for detecting a symbol timing of a multi-antenna radio communication system. The method can significantly reduce a calculation amount in a space division multiplex OFDM system as compared to the conventional method, can detect an accurate symbol timing, and can easily be realized. In this method, at the symbol timing stage, a transmission side transmits a timing training sequence only from the first antenna. A reception side has a symbol timing divided into a rough timing stage and an accurate timing stage. In the rough timing stage, a phase correlation value between the reception signal of each antenna and its delay is calculated. The correlation value outputs of the respective antenna terminals are combined to decide the rough timing window. In the accurate timing stage, a convolution calculation is performed by using a real part of the reception symbol and a symbol of a real part of the training sequence. The convolution outputs of the respective antenna terminals are combined to obtain a plurality of output peak values. Within the rough timing window, the last convolution peak value is searched, thereby realizing the highly accurate timing of the symbol.

### TECHNICAL FIELD

The present invention relates to a symbol timing detection method for a multi-antenna wireless communication system, and particularly relates to a symbol timing detection method for a new generation high-throughput wireless LAN such as a wireless LAN adopting a multi-antenna configuration.

### BACKGROUND ART

In accompaniment with the rapid development of wireless LANs (WLANs) for communication applications, due to the need to provide high-quality services to users, the development of new generation WLANs having higher throughput and higher network capacity has been required. In recent years, the IEEE standard committee has established the 802.11n task group—namely, a high-throughput task group (HTTG)—in order to define a new generation WLAN standard that aims at a physical layer data rate of 250Mbps and an actual throughput of 100 Mbps or more based on the 802.11a/g standard.

802.11a, which is the current LAN standard, is based on the orthogonal frequency division multiplexing (OFDM) scheme. As the technical means having high potential to increase the data transmission rate of this standard, a technique is included where multi-antenna technique (MIMO) is adopted on the transmission side and the receiving side and, by MIMO-OFDM combining MIMO and OFDM, the advantages of MIMO of high spectrum efficiency and high data rate and the advantages of OFDM of frequency selective fading resistance are both satisfied.

Compared to packet switching high-speed WLAN systems adopting a random access protocol, due to features of randomness of packet arrival time and a high rate, implementation of rapid timing synchronization upon reception of a certain packet is required. However, there are currently few publications relating to research on timing synchronization of MIMO-OFDM.

A method shown in non-patent document 1 is an improvement on a mono-antenna OFDM symbol timing algorithm. First, a complex autocorrelation value and power for the received signal are calculated, a rough timing position is decided using maximum normalized correlation (MNC) criteria. A cross-correlation value for the received signal and the training sequence is then calculated, and a position where cross-correlation energy in a fixed search radius centered on the rough timing position is maximized is searched for to carry out accurate timing estimation.

The timing method disclosed in non-patent document 2 also has two stages of rough timing and accurate timing. The differences from the non-patent document 1 includes, firstly, using a modulated orthogonal sequence for the training sequence in non-patent document 2, and secondly, in the rough timing stage, deciding the rough timing window by calculating the ratio of a complex autocorrelation amplitude value of the receiving signal and power, instead of using MNC criteria.

However, both of the above methods adopt a method of sending training sequences for timing use simultaneously from a plurality of antennas, in the rough timing stage, calculating a rough timing position based on fixed criteria,in the accurate timing estimation stages, searching a position where the square of the cross-correlation amplitude is maximized in a fixed search radius centered on the rough timing position and taking the position as an accurate timing position, further, in the accurate timing estimation stage, using a method utilizing a long training sequence. This arises the problem that implementation cannot be implemented easily.
Non-patent document 1: Allert van zelst, Tim C. W. Schenk, et. Al., Implementation of MIMO OFDM-based wireless LAN system, IEEE Trans. SP, vol. 52, no. 2, pp. 483-493, February 2004)
Non-patent document 2: A. N. Mody, G. L. Stuber et. Al., Synchronization for MIMO OFDM systems. IEEE Global Comm. Conf., vol. 1, pp509-513, November 2001).

### DISCLOSURE OF INVENTION

### Problems to be Solved by the Invention

It is therefore an object of the present invention to provide a symbol timing detection method for a multi-antenna wireless communication system, which is able to reduce the amount of calculation substantially in space division multiplexing OFDM systems, compared to the related art, detect accurate symbol timing, and be implemented without difficulty.

### Means for Solving the Problem

A method of detecting symbol timing for a multi-antenna wireless communication system of the present invention including: at a transmission side, sending a timing training sequence from one antenna alone; and at a receiving side, receiving the signal sent from the transmission side using a plurality of antennas, calculating a complex correlation amplitude value for signals received by each of the antennas and a time delay of the received signals, synthesizing the complex correlation amplitude value output for each of the antennas, comparing the amplitude after the synthesis with a predetermined threshold value, deciding a rough timing window, carrying out a convolution operation for a symbol sequence of the signal received at each of the antennas and the timing training sequence, synthesizing convolution output results of each of the antennas, searching a final convolution peak value within the rough timing window, and detecting symbol timing.

A method of detecting symbol timing for a multi-antenna wireless communication system of the present invention including, at a transmission side, sending a timing training sequence from one antenna alone; and at a receiving side, receiving the signal sent from the transmission side using a plurality of antennas, calculating a complex correlation amplitude value for signals received by each of the antennas and a time delay of the received signals, synthesizing the complex correlation amplitude value output for each of the antennas, comparing the amplitude after the synthesis with a predetermined threshold value, deciding a rough timing window, carrying out a convolution operation for a real part of a symbol sequence of the signal received at each of the antennas and a real part of a timing training sequence, synthesizing convolution output results for each of the antennas, searching a final convolution peak value within the rough timing window, and detecting symbol timing.

### ADVANTAGEOUS EFFECT OF THE INVENTION

According to the present invention, it is possible to substantially reduce the amount of calculation in space division multiplexing OFDM systems compared to the related art, detect accurate symbol timing, and be implemented without difficulty.

### BRIEF DESCRIPTION OF THE DRAWINGS

FIG. 1A is a block view showing a configuration for a transmitter of a MIMO OFDM system of an embodiment of the present invention;

FIG. 1B is a block view showing a configuration for a receiver of a MIMO OFDM system of an embodiment of the present invention;

FIG. 2 shows a format for a training sequence for a multi-antenna system of an embodiment of the present invention;

FIG. 3 shows a training sequence of the IEEE802.11a standard of an embodiment of the present invention;

FIG. 4A is a block view showing symbol timing of an embodiment of the present invention;

FIG. 4B is a block view showing symbol timing of the related art;

FIG. 5A is a flowchart showing acquisition of a rough timing window of an embodiment of the present invention;

FIG. 5B is a flowchart showing acquisition of a rough timing position of the related art;

FIG. 6A shows the simulation results of an embodiment of the present invention;

FIG. 6B shows the simulation results of an embodiment of the present invention;

FIG. 7A shows autocorrelation amplitude values of an embodiment of the present invention;

FIG. 7B further shows autocorrelation amplitude values of an embodiment of the present invention;

FIG. 8A is a flowchart showing cross-correlation processing according to an embodiment of the present invention;

FIG. 8B is a flowchart showing cross-correlation processing of the related art;

FIG. 9A shows convolution output amplitude values of an embodiment of the present invention;

FIG. 9B shows further convolution output amplitude values of an embodiment of the present invention;

FIG. 10A shows convolution amplitude values of an embodiment of the present invention;

FIG. 10B shows further convolution amplitude values of an embodiment of the present invention;

FIG. 11A shows a search start sample position at a rough timing window of an embodiment of the present invention;

FIG. 11B shows a search start sample position at a rough timing window of an embodiment of the present invention; and

FIG. 12 shows a symbol timing algorithm of an embodiment of the present invention.

### BEST MODE FOR CARRYING OUT THE INVENTION

### Embodiment

An embodiment of the present invention will be described below in detail with reference to the accompanying drawings. The embodiment below is described for the purpose of explanation, and this does not limit the scope of the invention.

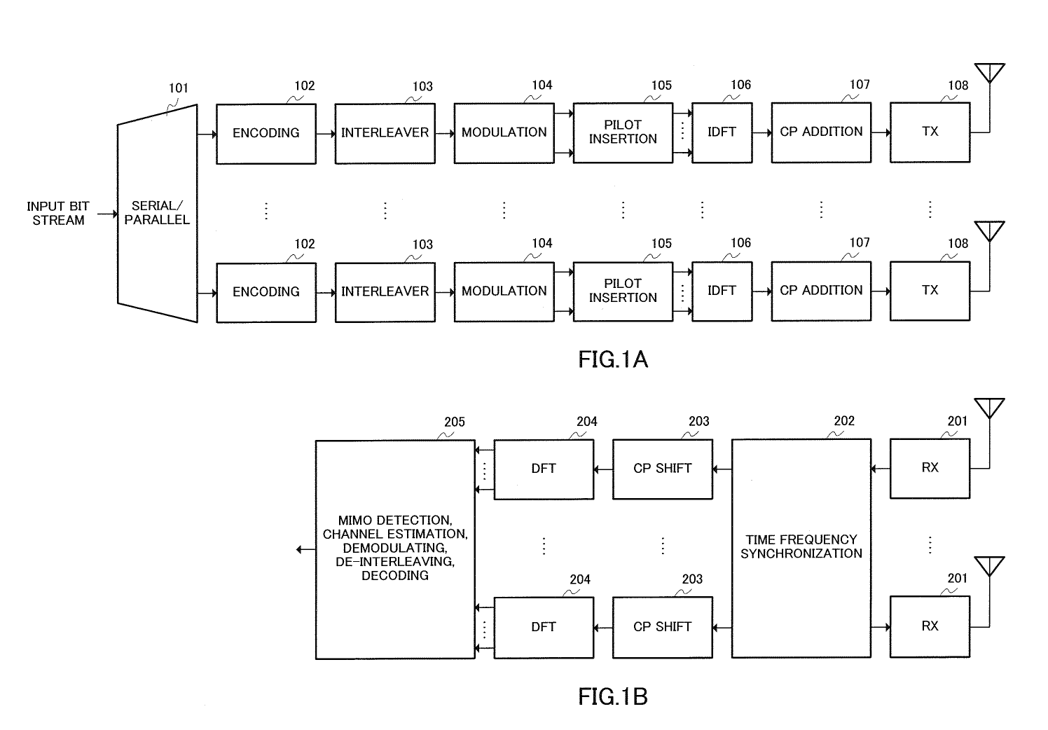

The present invention is based on the OFDM communication system such as IEEE802.11a and developed to be a multi-antenna system configuration where Nₜ antennas are arranged on the transmission side and Nᵣ antennas are arranged on the receiving side. In the transmission side system, as shown in FIG. 1A, serial/parallel conversion section 101 multiplexes an inputted bit stream to give Nₜ symbol substreams. Encoding section 102 then carries out channel encoding on the inputted bit stream and increases noise resistance. Interleaver 103 carries out interleave processing on the encoded output and reduces correlation of the bit stream. Modulation section 104 modulates the outputted bit stream of interleaver 103 to give a symbol stream. Pilot insertion section 105 inserts pilot sequences for timing and channel estimation use into the transmitted symbol stream. IDFT section 106 carries out discrete Fourier inverse transformation (IDFT) on point N_{c} at the modulated symbol stream. CP assigning section 107 inserts a cyclic prefix (CP) to the symbol stream after IDFT processing. TX section 108 carries out carrier modulation on the acquired OFDM baseband symbol and then transmits the result.

At the receiving side system, as shown in FIG. 1B, RX section 201 carries out down-conversion on the received OFDM carrier signal and makes it into a baseband symbol. Time frequency synchronizing section 202 carries out frequency synchronization on the baseband symbol and the symbol timing. CP shift section 203 deletes the cyclic prefix of the OFDM symbol. DFT section 204 carries out discrete Fourier transformation (DFT) at point N_{c}. MIMO detecting, channel estimating, demodulating, interleaving, and decoding section 205 then carries out received signal processing, channel estimation, demodulation, interleaving and decoding on the DFT output and then returns the result to an information bit stream.

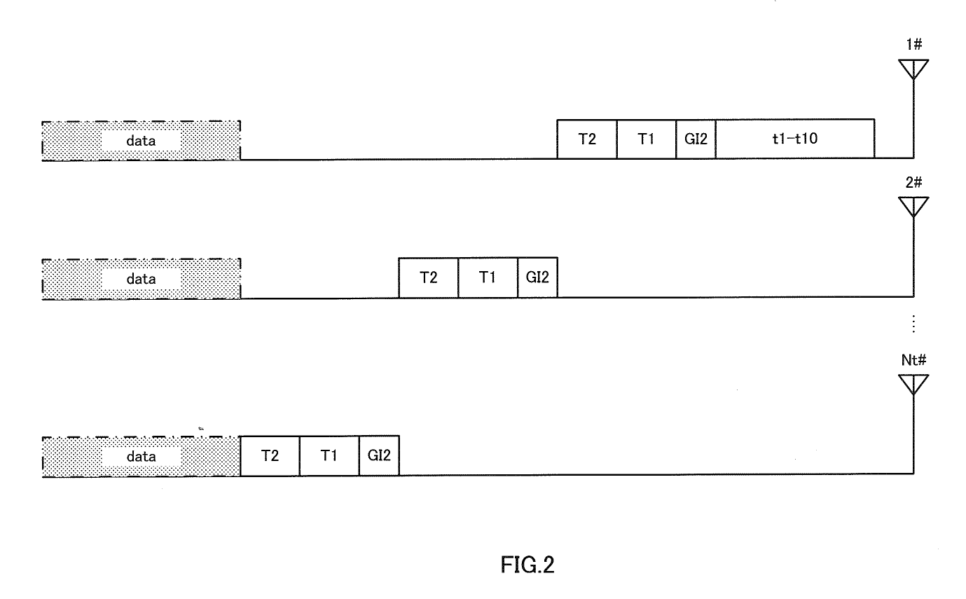

With multi-antenna systems, the setting of the training sequence (also referred to as pilot sequence or preamble) is an important problem. Although, to estimate subchannels from each transmission antenna to signal receiving antennas, training sequences between different antennas have to be set in orthogonal or time-shift orthogonal. The present invention uses a time shift orthogonal method where, if a duration of the training sequence is Tₚ, training sequences sent by the antennas shift by time Tₚ. The total length of the system training sequence increases linearly according to the number of transmission antennas Nₜ. Therefore, for simplification, with the present invention, a training sequence portion used in timing is only sent from the first antenna, and as shown in FIG. 2, t1 to t10 of antenna 1# is the timing training sequence.

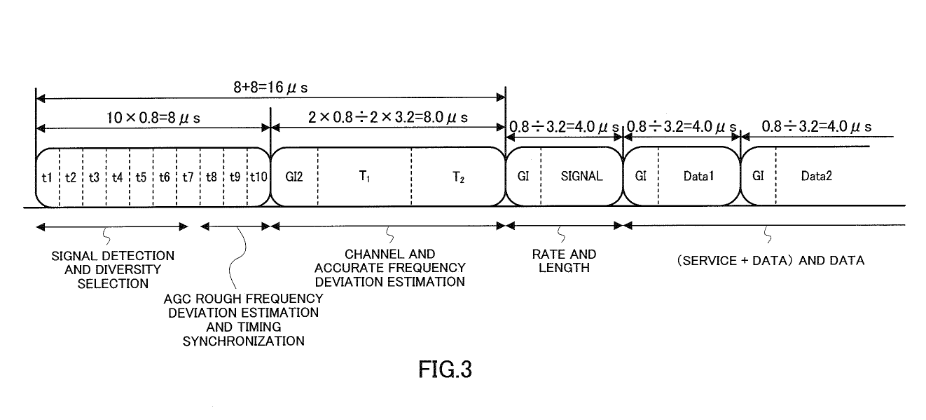

FIG. 3 shows a format for a preamble training sequence defined in the IEEE802.11a standard. The preamble training sequence is comprised of ten short symbols (t1 to t10) of duration 0.8 μs, and two long symbols (T1 to T2) of duration 3.2 μs. Of these, the short symbols (t1 to t10) are used for, for example, automatic gain control (AGC), symbol timing, and rough frequency deviation detection, and the long symbols (T1 to T2) are used in channel estimation and accurate frequency synchronization. G12 of duration 2×0.8 μs is a long symbol cyclic prefix. After the training sequence is a data symbol stream. The total duration of the long symbol sequence is 8 μs, which is two OFDM symbol periods (the duration of each OFDM symbol is 4 μs).

The frequency domain short symbol (length 64) within one IFFT period (64 carriers and duration 3.2 μs) defined in the IEEE 802.11a specification is represented by the following equation (1).

$$[ Equation 1 ]$$

$${S}_{- 32 , 31} = \sqrt{13 / 6} * \{ 0 , 0 , 0 , 0 , 0 , 0 , 0 , 0 , 1 + j , 0 , 0 , 0 , - 1 - \\ j , 0 , 0 , 0 , 1 + j , 0 , 0 , 0 - 1 - j , 0 , 0 , 0 , - 1 - j , 0 , 0 , 0 , 0 , 0 , 0 , 0 - \\ 1 - j , 0 , 0 , 0 , - 1 - j , 0 , 0 , 0 , 1 + j , 0 , 0 , 0 , 1 + j , 0 , 0 , 0 , 1 + \\ j , 0 , 0 , 0 , 0 , 0 , 0 , 0 \} \qquad ( 1 )$$

This is for transmitting symbols using twelve of the 64 subcarriers. The short sequence is standardized using the constant SQRT (13/6), and the average transmission power is 1. After IFFT processing of the 64 points is used in equation (1), the frequency domain short sequence is transformed to a time domain. This time domain short sequence (which is on the 64 carriers) is obtained by repeating the process of equation (2) four times,—that is, 16×4=64.

$$[ Equation 2 ]$$

$${r}_{short} = \{ 0.046 + j 0.046 , - 0.132 + j 0.002 , - 0.013 - \\ j 0.079 , 0.143 - j 0.013 , 0.092 , 0.143 - j 0.013 , - 0.013 - \\ j 0.079 , - 0.132 + j 0.002 , 0.046 + j 0.046 , 0.002 - j 0.132 , - \\ 0.079 + j 0.013 , - 0.013 + j 0.143 , 0.092 , - 0.013 + j 0.143 , - \\ 0.079 - j 0.013 , 0.002 - j 0.132 \} \qquad ( 2 )$$

Here, rₛₕₒᵣₜ is one time domain short symbol such as t1 and has a length of 16. By repeating rₛₕₒᵣₜ sequence ten times, it is possible to obtain the whole of the time domain short symbol sequence t1 to t10, which has a length of 160 and has periodic characteristics of having a length of 16 for one time domain short symbol.

The present invention is shown in the algorithm below based on these.

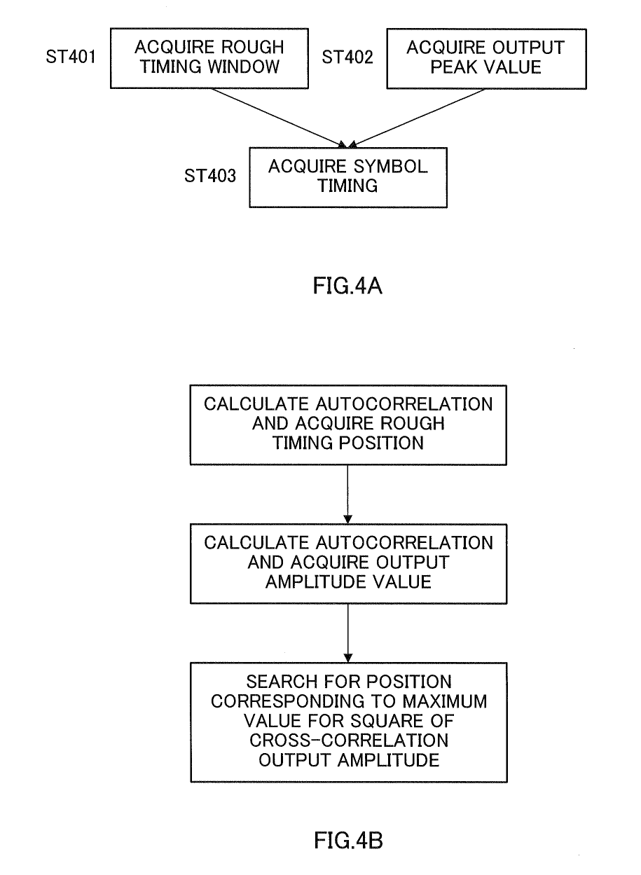

With the symbol timing detection method shown in the present invention, as shown in FIG. 4A, by obtaining a rough timing window by means of calculating autocorrelation of the received signal (step ST401), by obtaining an output peak value by means of calculating convolution for the received signal and the training sequence (step ST402), and by searching a final peak value finally at the rough timing window, a symbol timing position is obtained (step ST403). With the method of the present invention, it is possible to process autocorrelation calculations for the received signal and convolution operations for the received signal and the training in parallel. On the other hand, although the method shown in patent document 1 has, as shown in FIG. 4B, a step of calculating autocorrelation for the received signal and a step of calculating cross-correlation for the training sequence, the specific processing is different, and, therefore, detailed analysis is carried out below.

In the rough timing stage, autocorrelation is calculated for the received symbol and the time delay for the received symbol at each receiving antenna terminal. After autocorrelation output amplitude for each antenna is synthesized, the result is compared to a predetermined threshold value and a rough timing window is obtained. It is then necessary to adaptively adjust the threshold value in accordance with channel conditions due to change in the channel environment.

The autocorrelation output amplitude value is expressed as a relatively flat section rather than as a single peakvalue, and, when SIR is low, it is not possible to determine a start sample accurately. However, it is possible to obtain a rough timing window namely, a relatively flat section, by comparing threshold values.

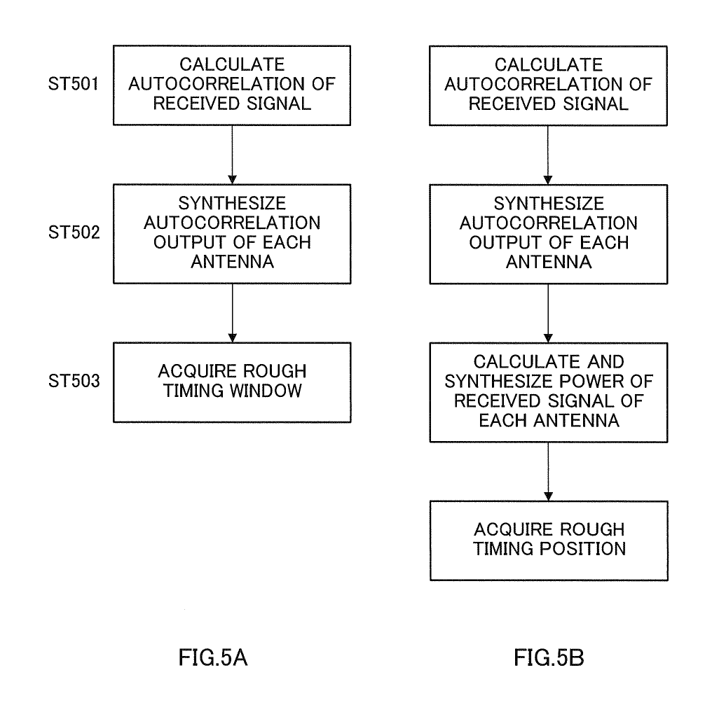

FIG. 5A is a flowchart showing acquisition of a rough timing window of this embodiment. First, autocorrelation for the received signal is calculated (step ST501), and an autocorrelation output of each antenna is synthesized using equation (3) below using spatial diversity characteristics of the multi-antenna receiving system (step ST502).

$$\begin{matrix}[ Equation 3 ] & \\ Λ ( n ) = {\sum }_{k = 0}^{N} {\sum }_{q = 1}^{{N}_{r}} {r}_{q} ( k + n ) {r}_{q} * ( k + n + L ) & ( 3 )\end{matrix}$$

Here, A is defined as the complex correlation of the received sequence and L time-delayed samples, r_{q}(n) is n samples received by the q^{th} antenna, an N is the number of FFT points (i.e. OFDM subcarrier number). The amplitude of Λ is compared to a fixed threshold value, and a rough timing window is obtained (step ST503). The threshold value is then adaptively adjusted in accordance with channel conditions due to change the channel environment. As shown in FIG. 5B, the method of patent document 1 first calculates the autocorrelation of the received signal and the time delay for the received signal, the autocorrelation of the received signal, and the power of the received signal, and then decides the rough timing position using maximum normalizing criteria (MNC).

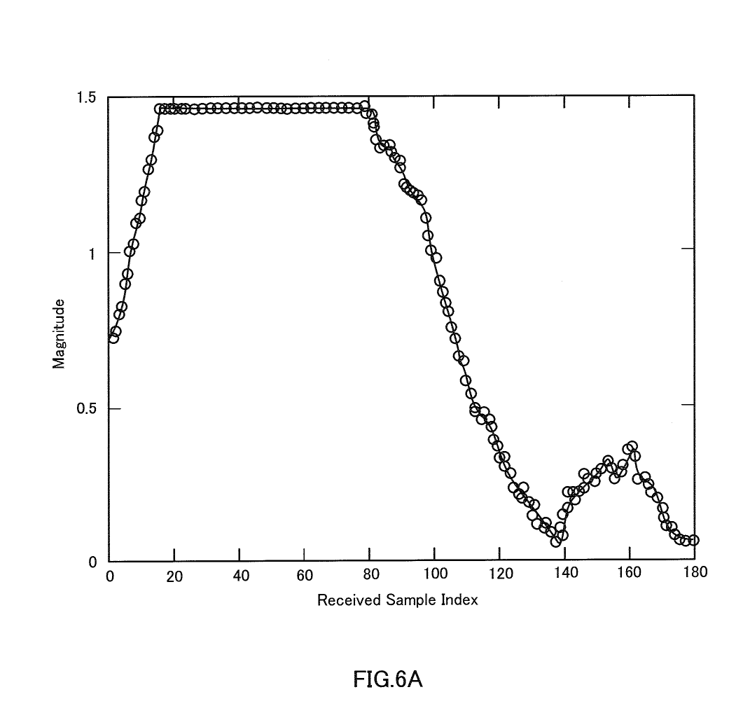

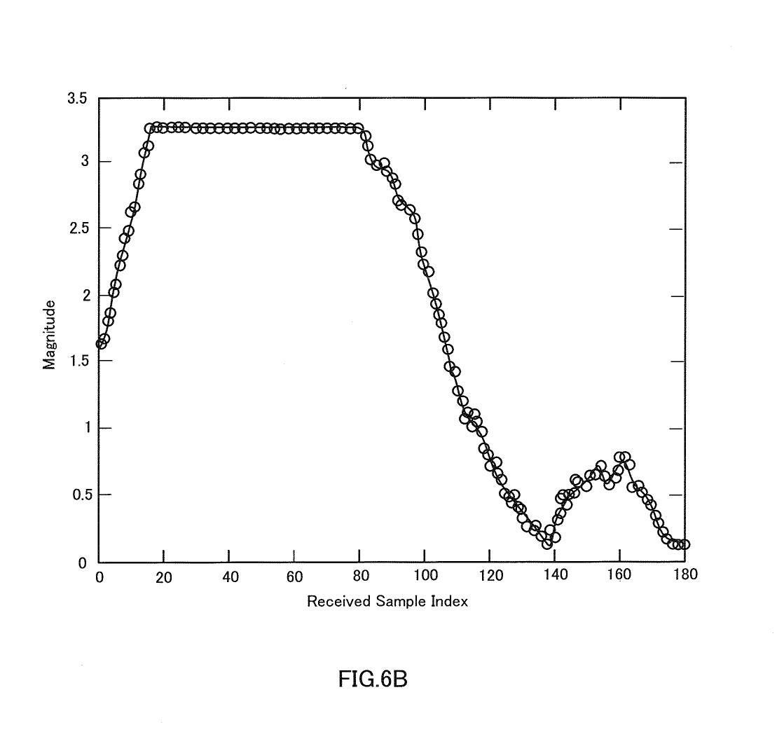

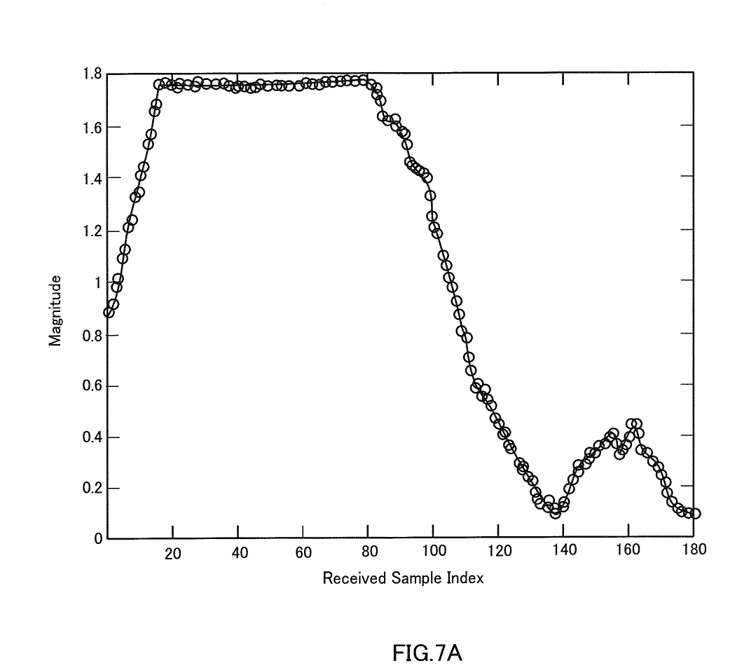

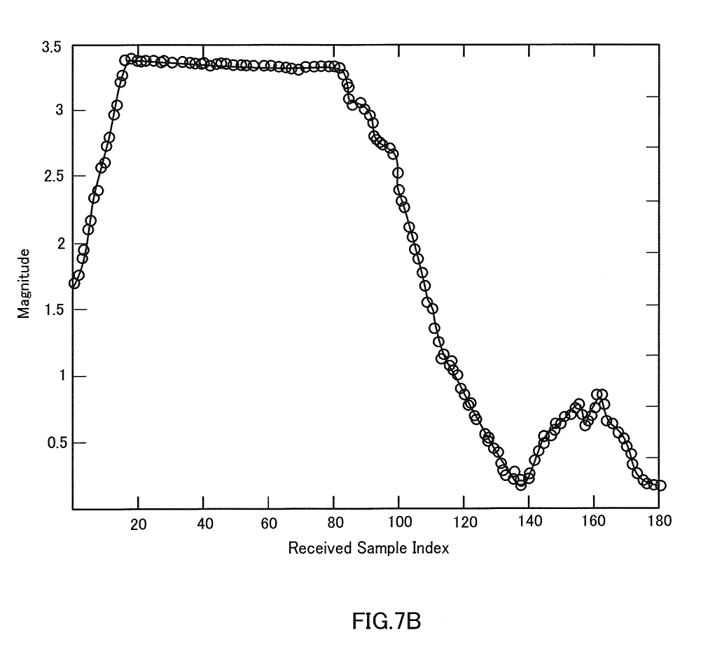

The results of rough timing simulation are shown in FIG. 6A to FIG. 7B. Assume that, during the simulation, the number of times for implementation of all the channels is 100, each OFDM subcarrier samples one sample, and for the system parameters, IFFT and FFT of 64 points and a length of CP of 16 are employed to match with the IEEE802.11 a standard, and time delay L is 16 (not described separately). FIG. 6A and FIG. 6B show autocorrelation amplitude values when flat fading channels and noise are not added. FIG. 6A shows the results of output of a system with two transmission antennas and two receiving antennas, and FIG. 6B shows the output results of a system with four transmission antennas and four receiving antennas. FIG. 7A and FIG. 7B show autocorrelation amplitude values of flat fading channels and low received signal versus noise ratio environments (where the received signal to noise ratio of each channel is 0 dB). FIG. 7A shows the output of a system with two transmission antennas and two receiving antennas, and FIG. 7B shows the output of a system with four transmission antennas and four receiving antennas.

As understood from FIG. 6A to FIG. 7B, the curve first rises to a fixed value, becomes relatively flat for the duration of the N samples, and finally falls to a fixed value. When noise is not added (FIG. 6A and FIG. 6B) the curve is flatter than when noise is added (FIG. 7A and FIG. 7B). The object here is to detect the position of the (N+CP+1) th sample from the first received sample, and this embodiment has (64+16+1)=81 samples. These correlation output amplitude value are expressed as a relatively flat section rather than as a single peak value, and, when SIR is low, it is not possible to determine a start sample accurately. However, by comparing threshold values (the threshold value of FIG. 6A can be set to 1.45, and the threshold value of FIG. 6B can be set to 3.25), it is possible to obtain a relatively flat section, that is, a rough timing window.

It is therefore possible to implement accurate detection of timing using the algorithm below.

The present invention utilizes periodic characteristics of the short sequence, carries out a convolution operation on the received signal for each antenna and one short symbol, and synthesizes the convolution results of the antennas. For ease of implementation, it is preferable to carry out a convolution operation for only symbols of the real part of the short sequence and the real part of the received signal. A plurality of convolution output peak values are then obtained. Finally, by combining the obtained rough timing windows and searching the final convolution output peak value within this window, it is possible to determine the symbol timing position accurately.

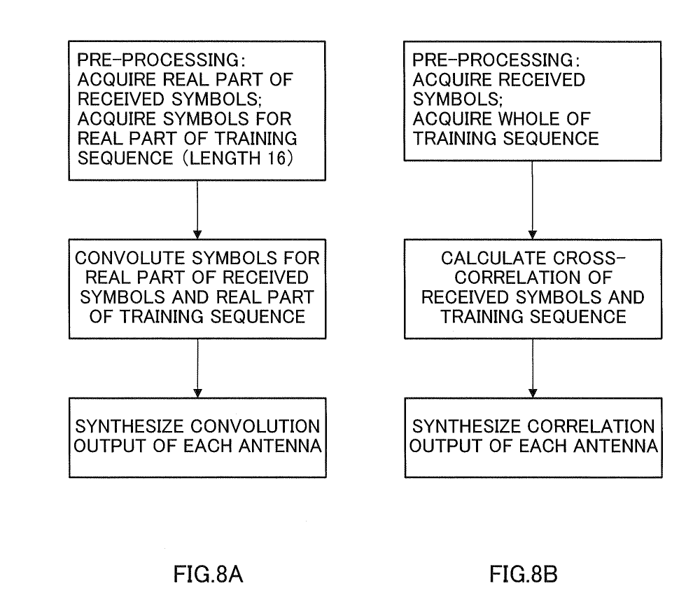

FIG. 8A is a flowchart showing convolution processing in this embodiment. A convolution operation is then carried out for the received sequence for each antenna and one short symbol (length 16) using the periodic characteristics of the time domain short symbol sequence, and, similarly, convolution results for each antenna are synthesized using spatial diversity characteristics as shown in equation (4).

$$\begin{matrix}[ Equation 4 ] & \\ C ( n ) = {\sum }_{k = 0}^{N} {\sum }_{q = 1}^{{N}_{r}} Re [ {r}_{q} ( k + n ) ] ⊗ Re [ {r}_{short} ] & ( 4 )\end{matrix}$$

where \hat{×} indicates convolution.

To avoid system complexity, convolution processing is carried out for only the symbol for the real part of rₛₕₒᵣₜ and r_{q}(n). However, the present invention is by no means limited to this, and a convolution operation for the complex number rₛₕₒᵣₜ and r_{q}(n) may also be carried out. FIG. 8B is a flowchart of cross-correlation processing of a method of the related art, where a correlation operation is carried out for the whole of the received signal and the training sequence. The calculation is complex compared to the method of FIG. 8.

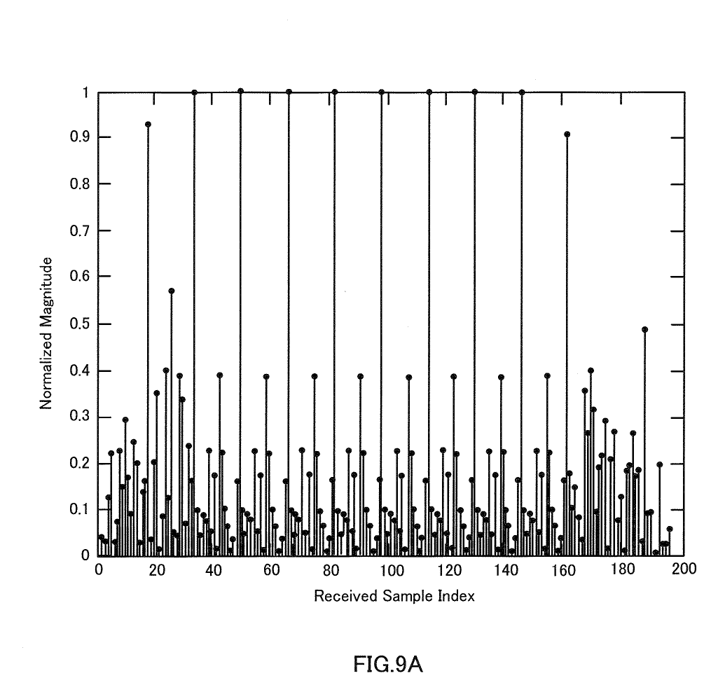

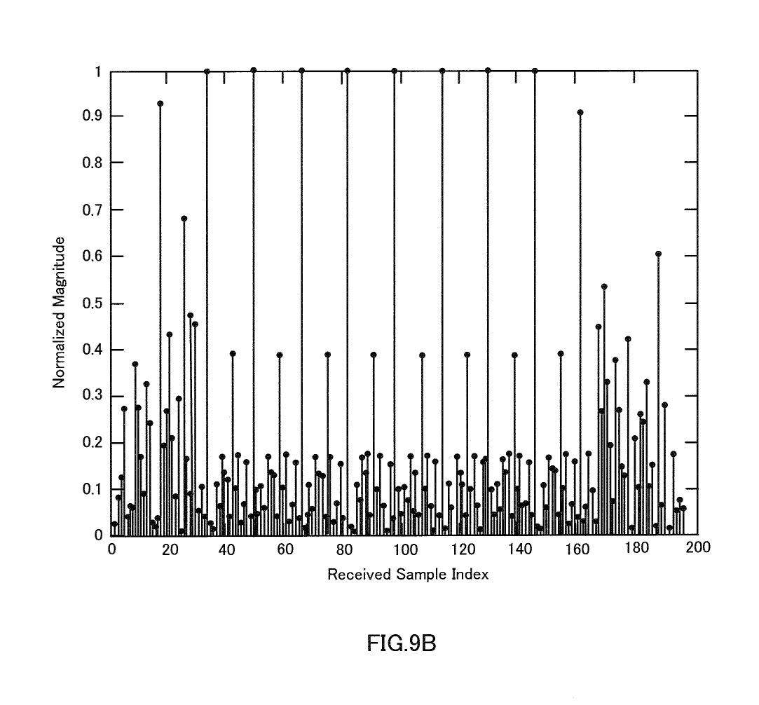

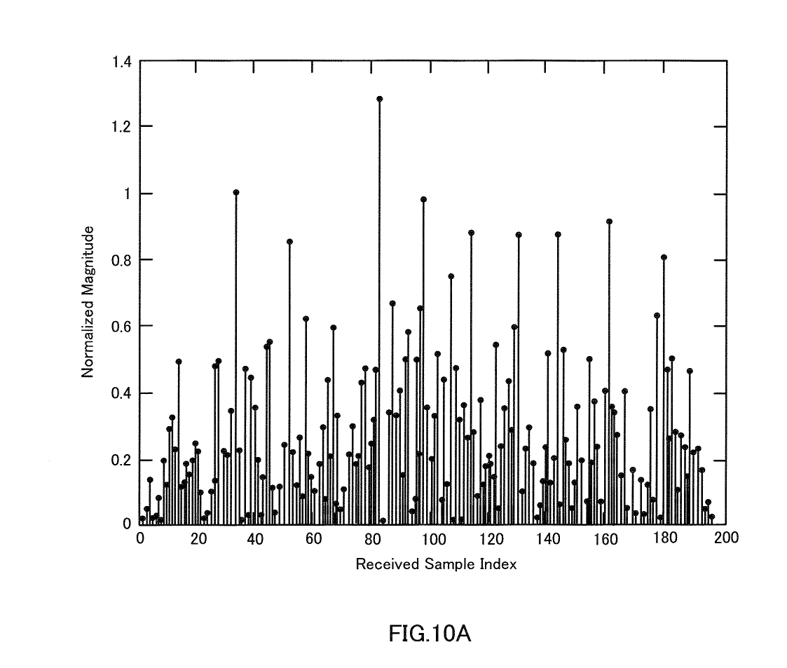

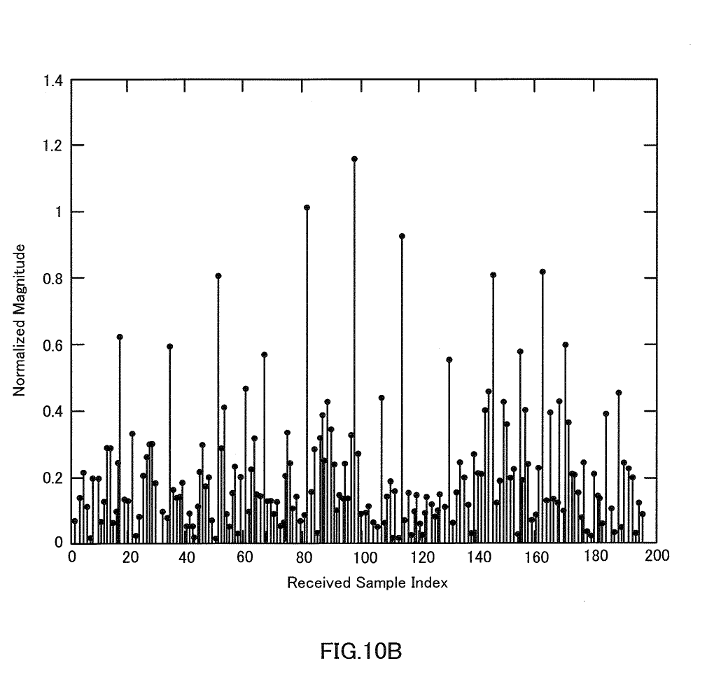

FIG. 9A and FIG. 9B show convolution amplitude values when flat fading channels and noise are not added, FIG. 9A shows the output of a system with two transmission antennas and two receiving antennas, and FIG. 9B shows the output of a system with four transmission antennas and four receiving antennas. FIG. 10A and FIG. 10B show convolution output amplitude values (all normalized) for a flat fading channel and low received signal to noise ratio environment (where the received signal to noise ratio of each antenna is 0 dB), where FIG. 10A shows the output of a system with two transmission antennas and two receiving antennas, and FIG. 10B shows the output of a system with four transmission antennas and four receiving antennas, where appearance of convoluted output peak values is recognized with a period of the short symbol length. When FIG. 9A and FIG. 9B and FIG. 10A and FIG. 10B are compared, substantial distortion occurs in the peak value output after noise is added. It is therefore difficult to determine the position of the timing using only cross-correlation, and it can therefore be understood that it is necessary to combine the autocorrelation results. Further, when FIG. 10A and FIG. 10B are compared, it can be acknowledged that the influence of noise can be reduced using multi-receiving antenna diversity.

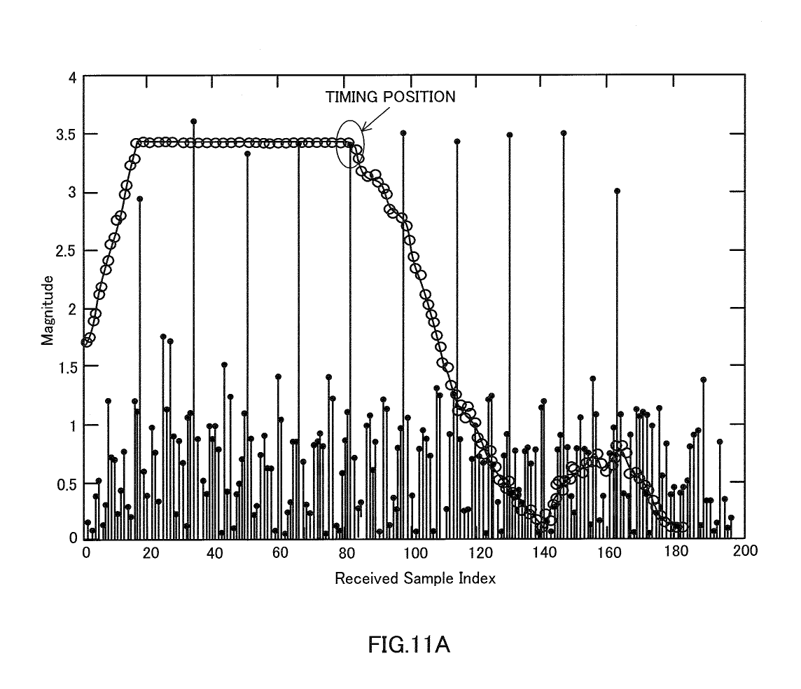

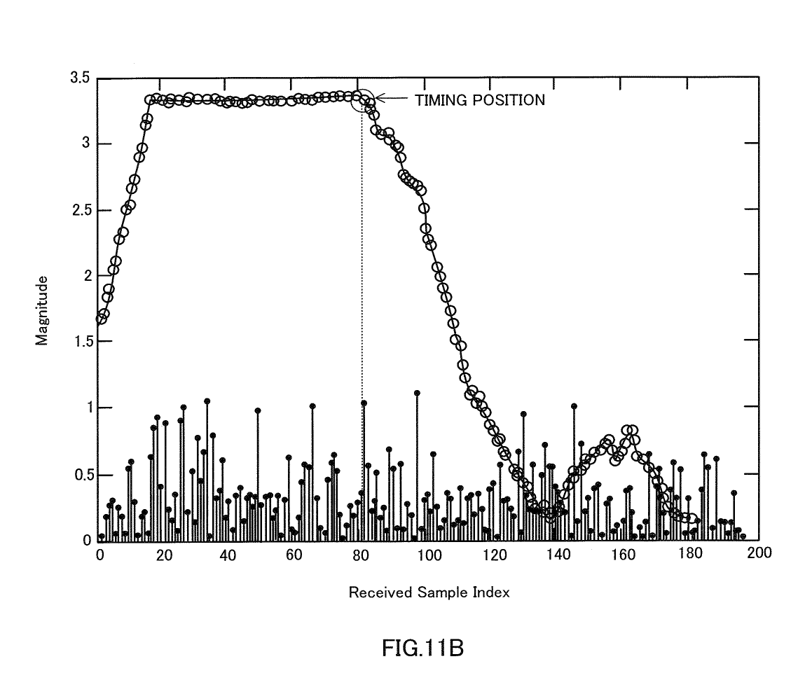

Finally, the obtained rough timing windows are combined but as shown in FIG. 11A and FIG. 11B, if the final convolution output peak value within the window is searched, it is possible to accurately determine the (N+CP+1)^{th} sample point. FIG. 11A shows the symbol timing results for the system in flat fading under the condition that the received signal to noise ratio at each antenna is 10 dB with four transmission antennas and four receiving antennas. The rough synchronization threshold value is set to 3.4. FIG. 11B shows the symbol timing results for the system in flat fading under the condition that the received signal to noise ratio at each antenna is 0 dB with four transmission antennas and four receiving antennas. The rough synchronization threshold value is set to 3.3. Here, it can therefore be understood that it is possible to accurately detect symbol timing with the method shown in the present invention regardless of the conditions such as in a general channel environment or in a low signal to noise ratio.

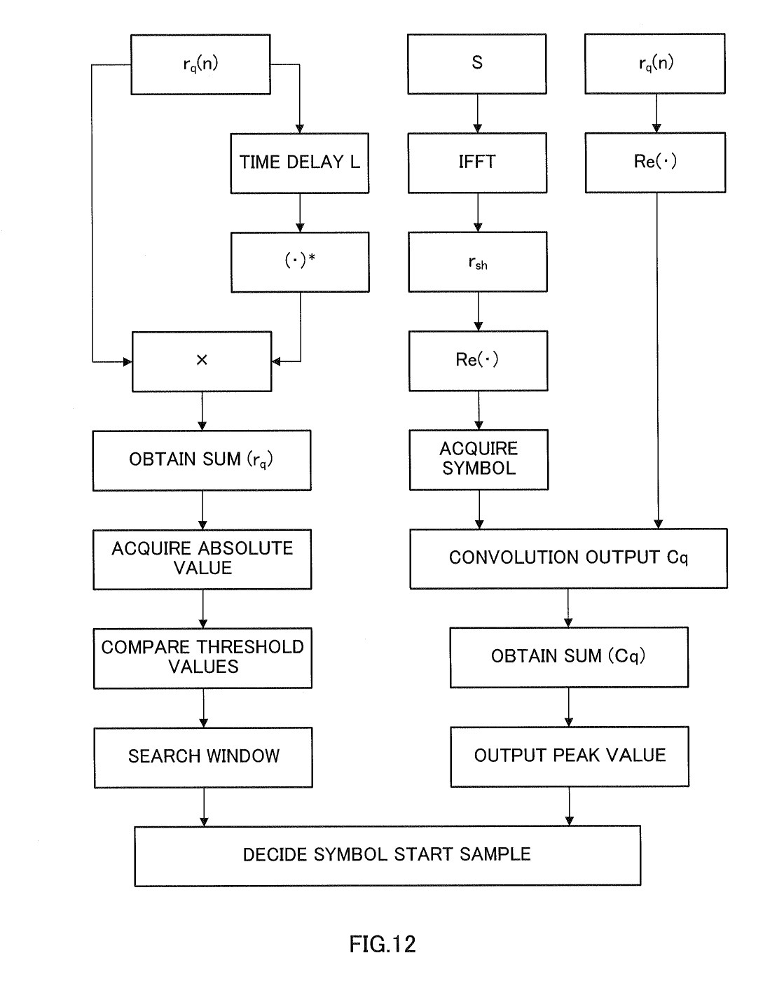

To summarize the above, the symbol timing algorithm shown in the present invention is as shown in FIG. 12. To increase processing speed, with the present invention, autocorrelation (the left side of the drawing) and a convolution operation (the right side of FIG. 12) are processed in parallel. During autocorrelation processing, a received signal sample for each antenna is r_{q}, and an autocorrelation output for each antenna is obtained by multiplying r_{q} with a signal acquiring the complex conjugate of time delay L of r_{q}. After synthesizing them and acquiring an absolute value, by comparing the result with a fixed threshold value, a search window (rough timing window) is obtained. During the convolution operation, after transforming a short training sequence in the frequency domain to in a time domain using an IFFT transformation,by selecting one short symbol from the sequence to obtain the symbol for the real part, acquiring the real part of the received signal for each antenna,carrying out a convolution operation on both to obtain an output C_{q}, and synthesizing convolution results for each antenna, an output peak value is obtained. Finally, system symbol timing is obtained by searching for a final peak value within the rough timing window.

The present invention has the advantages below. This is, the system sends the timing training sequence from one antenna alone, so that implementation is easy. Further, although, in the rough timing stage, the rough timing window is decided by directly calculating autocorrelation for the received signal and time delay of the received signal, with the method of the related art, the rough timing position is calculated based on a fixed measurement standard after calculating the autocorrelation of the time delay and power. Compared to the method of the related art, with the present invention, it is possible to omit the amount of calculation of, for example, power of the received signal or measurement standards. Further, in the accurate timing stage, although with the present invention, after calculating a convolution output for the received signal and the training sequence, timing position is decided by searching for a final convolution peak value in the rough timing window, with the method of the related art, a position where the square of the autocorrelation amplitude of the received symbol and the training sequence is maximized in a fixed search radius centered on the rough timing position, is searched and is taken as an accurate timing position. The search radius is not fixed, and, therefore, there is the possibility that the timing position obtained in different search radii may also be different, and timing errors may be caused. Further, during calculating cross-correlation, although with the present invention, periodicity characteristics of the short symbol sequence of the preamble sequence of the 802.lla standard is utilized and a convolution operation is carried out using only the real part of the received signal and symbols in the real part of the short symbol sequence of length 16, with the method of the related art, a correlation operation is carried out using the real part and imaginary part of the received signal and the real part and imaginary part of the whole of the reference sequence (length>16). Compared to the method of the related art, the present invention is easy to be implemented. Further, by utilizing the spatial diversity characteristic of the multi-antenna system and carrying out processing after synthesizing the output of each antenna in both of the rough timing stage and the accurate timing stage, the influence of noise is small.

As described above, the present invention is described by illustrating a typical embodiment. It is obvious for those skilled in the art that various modifications, substitutions and additions are possible without deviating from the conceptual scope of the present invention.

### INDUSTRIAL APPLICABILITY

The symbol timing detection method of the multi-antenna wireless communication system according to the present invention is particularly suitable for new generation high throughput wireless LANs such as wireless LANs adopting a multi-antenna configuration.

1. A method of detecting symbol timing for a multi-antenna wireless communication system, the method comprising:
at a transmission side, sending a timing training sequence from one antenna alone; and
at a receiving side, receiving the signal sent from the transmission side using a plurality of antennas, calculating a complex correlation amplitude value for signals received by each of the antennas and a time delay of the received signals, synthesizing the complex correlation amplitude value output for each of the antennas, comparing the amplitude after the synthesis with a predetermined threshold value, deciding a rough timing window, carrying out a convolution operation for a symbol sequence of the signal received at each of the antennas and the timing training sequence, synthesizing convolution output results of each of the antennas, searching a final convolution peak value within the rough timing window, and detecting symbol timing.

2. The method of detecting symbol timing for a multi-antenna wireless communication system according to claim 1, wherein the timing training sequence is a short symbol sequence.

3. The method of detecting symbol timing for a multi-antenna wireless communication system according to claim 1, wherein the predetermined threshold value is adaptively adjusted based on channel conditions.

4. The method of detecting symbol timing for a multi-antenna wireless communication system according to claim 1, wherein the multi-antenna wireless communication system is a multi-antenna orthogonal frequency division multiplexing system using a spatial division multiplexing scheme.

5. A method of detecting symbol timing for a multi-antenna wireless communication system, the method comprising:
at a transmission side, sending a timing training sequence from one antenna alone; and
at a receiving side, receiving the signal sent from the transmission side using a plurality of antennas, calculating a complex correlation amplitude value for signals received by each of the antennas and a time delay of the received signals, synthesizing the complex correlation amplitude value output for each of the antennas, comparing the amplitude after the synthesis with a predetermined threshold value, deciding a rough timing window, carrying out a convolution operation for a real part of a symbol sequence of the signal received at each of the antennas and a real part of a timing training sequence, synthesizing convolution output results for each of the antennas, searching a final convolution peak value within the rough timing window, and detecting symbol timing.

6. The method of detecting symbol timing for a multi-antenna wireless communication system according to claim 5, wherein the timing training sequence is a short symbol sequence.

7. The method of detecting symbol timing for a multi-antenna wireless communication system according to claim 5, wherein the predetermined threshold value is adaptively adjusted based on channel conditions.

8. The method of detecting symbol timing for a multi-antenna wireless communication system according to claim 5, wherein the multi-antenna wireless communication system is a multi-antenna orthogonal frequency division multiplexing system using a spatial division multiplexing scheme.
